(19) United States
(12) Patent Application Publication
(10) Pub. No.: US 2002/0053169 A1
(43) Pub. Date: May 9, 2002

(54) Opening and closure device for sliding door

(75) Inventor: Angelo Menuzzo, Preganziol (IT)

Correspondence Address: MODIANO & ASSOCIATI, Via Meravigli, 16, MILANO, 20123, IT

(73) Assignee: DITEC S.p.A.

(21) Appl. No.: 09/984,241

(22) Filed: Oct. 29, 2001

(30) Foreign Application Priority Data
Nov. 6, 2000 (IT) TV2000U000047

(51) Int. Cl. E05F 11/00

(52) U.S. Cl. 49/360

(57) ABSTRACT

An opening and closure device for a sliding door, comprising a first driving motor for moving first driving elements associated with the sliding door and second sliding and guiding means interposed between the sliding door and a fixed frame. Said device has a second auxiliary motor that is suitable to produce a first opening movement of the door.

### BACKGROUND OF THE INVENTION

The present invention relates to an opening and closure device for sliding doors, particularly suitable for the movement of sliding and/or sealed doors, for example of sterile or refrigerated rooms.

Currently, doors which are operated by an electric motor and can slide horizontally along sliding guides advantageously arranged above and below said doors are used for example at the entrance of buildings such as banks, supermarkets or shopping centers.

In applications such as sterile rooms of hospitals or research institutes or refrigerated rooms for preserving food, it is necessary to perform a closure that is as hermetic as possible, so as to prevent the passage of infiltrations of unpurified air in the first case, and the flow of heat into the space to be refrigerated in the second case.

Accordingly, in both such situations sliding doors are used that are not only able to move horizontally but can also simultaneously perform, once they have reached the closure position, a downward movement, resting in suitable first lateral gaskets and adhering to second gaskets arranged perimetrically to the door frame.

This particular movement in a transverse direction with respect to the plane of arrangement of the door is obtained by means of an appropriately shaped sliding guide, which is arranged above said door and interacts with rolling means associated with respective brackets that protrude above said door.

The main drawback of this known type of opening and closure device is the opening of the sliding door, since the electric motor designed to move it must overcome multiple contrasting forces.

In particular, the electric motor must overcome simultaneously the weight of the door, the friction of the gaskets on the edges of the door, and any sticking of said gaskets caused for example by the formation of ice or by the presence of other substances.

Another drawback affecting known devices arises directly from the preceding one, and consists of the fact that the force required for the horizontal movement of the sliding door is considerably smaller, even one hundred times smaller, than the forces produced during opening.

Therefore, although the electric motor operates almost always at very low or extremely low power, it must be sized according to the power peak required during opening, with considerable installation costs and considerable space occupation.

Moreover, said motor, by absorbing a high amount of power, requires an adequate power supply line, which in many cases is not easily available.

Another disadvantage consists in that said electric motor maintains a great actuation force also during the stroke and accordingly constitutes a possible source of danger.

Accordingly, many of said known types of opening and closure devices are necessarily provided with two or more anti-crushing safety systems, with a further cost increase.

Another known type of device for opening and closing sliding doors also uses a lever mechanism, which is actuated by the electric motor and multiplies the initial force.

This device only partially solves the above mentioned drawbacks; moreover, said lever mechanism increases the complexity of the entire device, increasing the probability of faults or other drawbacks.

Another important disadvantage consists in that said lever mechanism has a significant actuation time, producing a scarcely functional delay when passing rapidly through the sliding door.

### SUMMARY OF THE INVENTION

The aim of the present invention is therefore to solve the above mentioned technical problems, eliminating the drawbacks of the cited prior art by providing an invention that allows to obtain a closure and opening device for sliding doors, particularly for moving sealed doors for sterile or refrigerated rooms, that can be installed starting from a conventional device for non-sealed sliding doors, with low installation costs.

Within this aim, an object is to provide an invention that performs accurate control of the opening and closure forces, ensuring maximum safety though not having an anti-crushing system.

Another object is to provide an invention that has modest dimensions and low power supply costs, since it does not requires dedicated electrical lines.

Another object is to provide an invention that provides the user with rapid and immediate opening and closure times.

Another object is to provide an invention that is structurally simple and functional and has low manufacturing costs.

This aim and these and other objects which will become better apparent hereinafter are achieved by an opening and closure device for a sliding door, comprising a first motor for moving first driving means associated with said sliding door and second sliding and guiding means interposed between said sliding door and a fixed frame, characterized in that it has a second auxiliary motor that is suitable to produce a first opening movement of said door.

### BRIEF DESCRIPTION OF THE DRAWINGS

Further characteristics and advantages of the invention will become better apparent from the detailed description of a particular embodiment, illustrated only by way of non-limitative example in the accompanying drawings, wherein:

FIGS. 1 and 2 are respectively a front view and a side view of the invention, provided with a second motor of the worm-gear pusher type;

FIGS. 3 and 4 are respectively a front view and a side view of the invention provided with a second motor of the eccentric-element type;

FIG. 5 is a side view of a worm-gear pusher motor;

FIGS. 6 and 7 are a side view and a front view of an eccentric-element motor.

### DESCRIPTION OF THE PREFERRED EMBODIMENTS

With reference to the figures, the numeral 1 designates an opening and closure device for a sealing, sliding door 2 suitable to temporarily close a sterile or refrigerated room.

At least one first bracket, designated by the reference numeral 3, protrudes upward from said sealing, sliding door 2 and is adapted to engage appropriate first driving means 4 that is advantageously constituted for example by a chain or a belt.

The first driving means 4 is associated with a first driving motor, designated by the reference numeral 5, which is arranged above said sliding door 2, and is guided on one or more pulleys or sprockets 6 arranged at the same height as said first motor 5.

In this embodiment, the first driving motor 5, which is electric, is arranged proximate to the passage provided in the structure of the building and therefore for example above a first jamb 20a of the door frame, the pulley 6 being arranged for example above a second jamb 20b that lies opposite the first one.

The first driving motor 5 is sized according to the power required to perform only the horizontal sliding of the sliding door 2: accordingly, it has a reduced power rating and size.

Two or more second brackets, designated by the reference numerals 7a and 7b, also protrude above said sliding door 2 and have, at their free end, suitable sliding elements, such as pairs of wheels 8a and 8b, which interact with second sliding and guiding means respectively designated by the reference numerals 9a and 9b.

Said second sliding and guiding means 9a and 9b, interposed between said sliding door 2 and a fixed frame, designated by the reference numeral 10, are advantageously constituted by an inclined rail suitable to guide the pairs of wheels 8a and 8b.

The second sliding and guiding means 9a and 9b are longitudinally arranged horizontally and are shaped, in their end portion, so as to allow a first movement of said sliding door 2 simultaneously in the opening direction, upward and away from the wall with which said sliding door 2 is associated.

The opening and closure device 1 comprises a second auxiliary motor, designated by the reference numerals 11a or 11b, that is suitable to produce or facilitate the first opening movement of said sliding door 2.

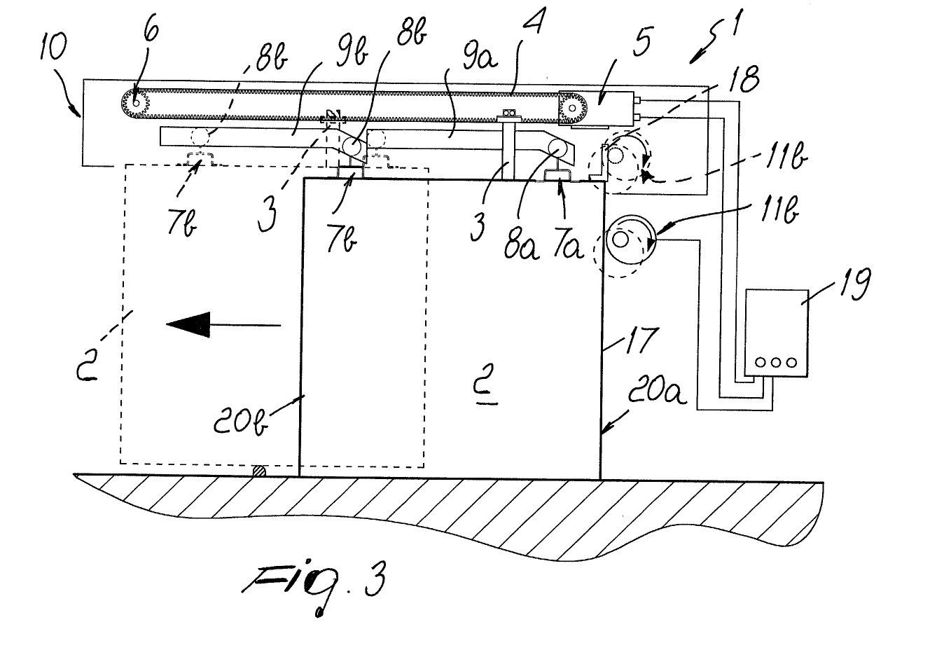

Said second auxiliary motor is advantageously constituted, in a first embodiment shown in FIG. 5, by a worm-gear pusher motor 11a that comprises a first electric motor 12a associated with a first reduction unit 13a suitable to convert the rotary motion of a first driving shaft, not shown in the figures, considered comprised in a known way in the reduction unit, into the advancement movement of a piston designated by the reference numeral 14.

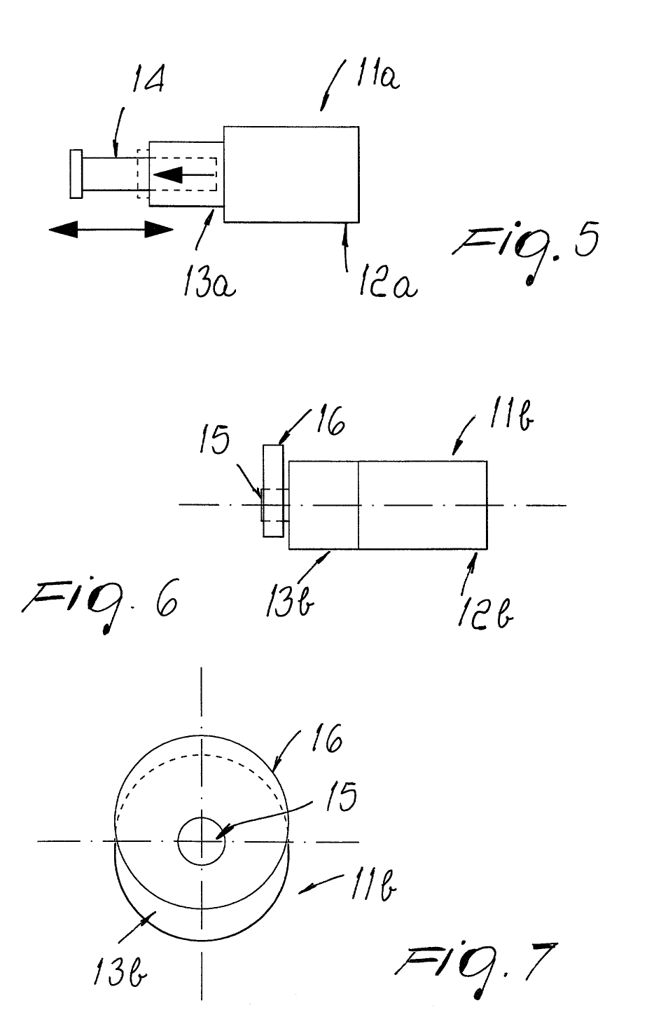

In a second embodiment, shown in FIG. 6, the second auxiliary motor is constituted for example by an eccentric-element motor 11b that comprises a second electric motor 12bthat interacts with a second reduction unit 13b.

A second driving shaft, designated by the reference numeral 15, protrudes axially from said second reduction unit 13b and an eccentric bearing 16 is keyed on said shaft, the perimetric edge of said eccentric bearing 6 interacting, during said first opening movement, with said surface 17, 18 that is rigidly coupled to said sliding door 2.

Said second auxiliary motor 11a or 11b is advantageously arranged at one end of the passage to be closed, for example at the first jamb 20a, acting directly on an abutting surface, in particular that of the lateral edge, designated by the reference numeral 17, of said sliding door 2 or of a lug 18 that protrudes for example upward from said door.

The first driving motor 5 and the second auxiliary motor 11a or 11b are actuated by suitable control and synchronization means, which preferably can be activated by means of a control panel 19.

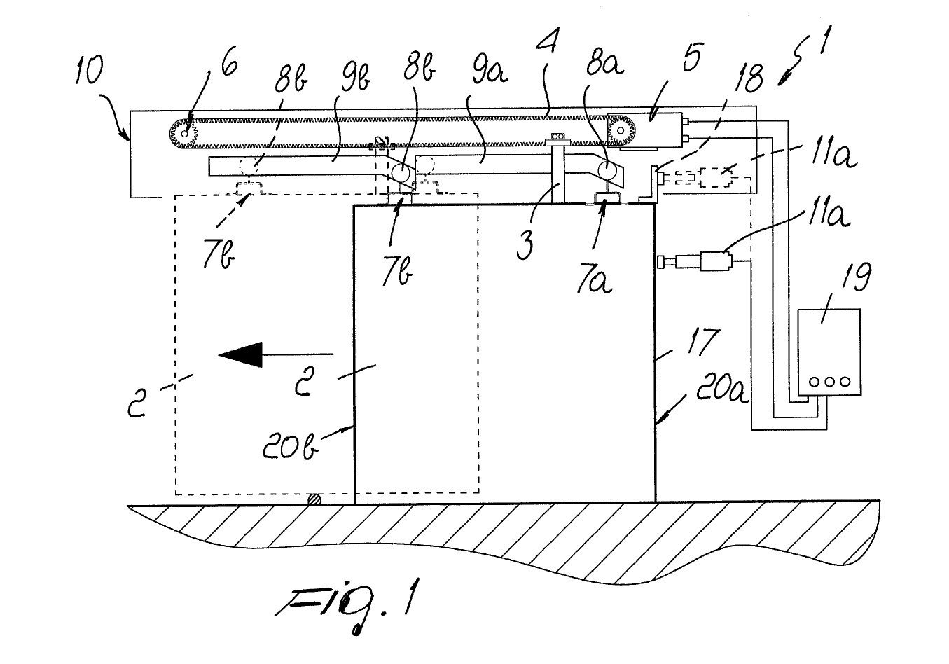

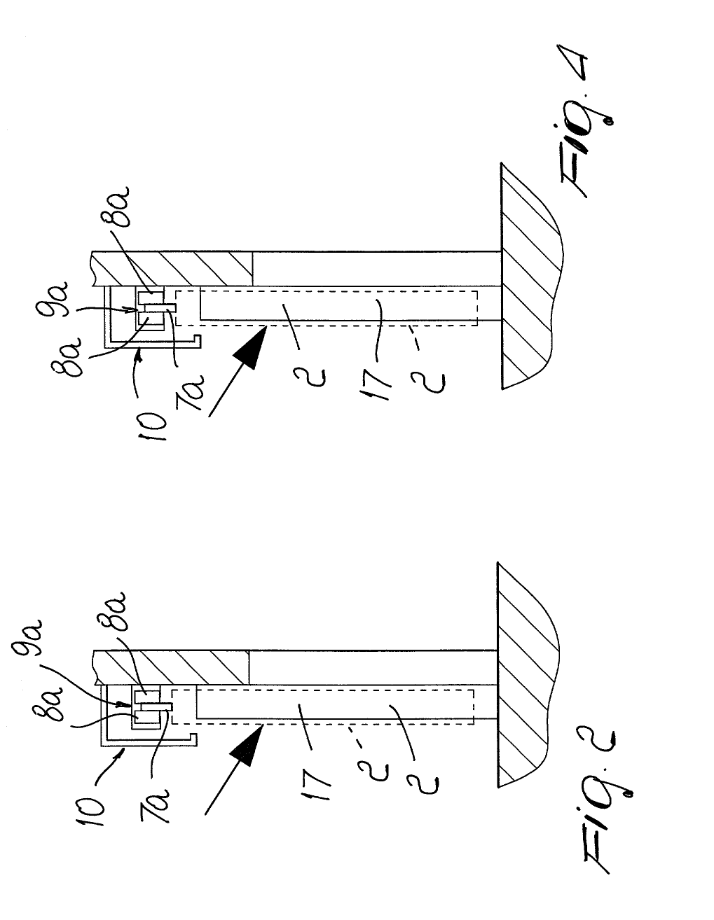

Operation is therefore as follows: with reference to FIGS. 1 or 3, the first opening movement of the sliding door 2 is performed mainly by the second auxiliary motor, which can be for example of the worm-screw pusher type 11a or of the eccentric-element type 11b.

Said second auxiliary motor is preferably very powerful, so as to easily overcome the friction and inertia forces caused by the presence of the gaskets and possibly also of ice.

Once said first opening movement, which measures a few millimeters, has been completed, the first motor 5 takes over for the remaining opening movement, for which a considerably smaller opening force is sufficient.

It has thus been found that the invention has achieved the intended aim and objects, an opening and closure device for sliding and sealing doors, particularly for sterile or refrigerated rooms, having been devised which can be easily installed starting from a conventional device for non-sealed sliding doors, thus reducing manufacturing and installation costs.

Said opening device is furthermore highly effective from the point of view of control of the opening and closure forces, ensuring maximum safety for the user although it may have no anti-crushing systems.

The invention further has small dimensions, low power supply costs, and shorter opening and closure times.

The invention is of course susceptible of numerous modifications and variations, all of which are within the scope of the appended claims.

Thus, for example, the second auxiliary motor 11a or 11b can be of any type, the use of worm-screw pusher motors 11a or of eccentric-element motors 11b being merely an example.

The materials used, as well as the dimensions that constitute the individual components of the invention, may of course be selected to be the most pertinent, according to specific requirements.

The disclosures in Italian Utility Model Application No. TV2000U000047 from which this application claims priority are incorporated herein by reference.

What is claimed is:

1. An opening and closure device for a sliding door mounted at a fixed frame for sliding movement between positions for closing and opening a passage, the device comprising: first driving means being in driving connection with said sliding door for actuation thereof; a first driving motor for actuating said first driving means; second sliding and guiding means, interposed between said sliding door and the fixed frame; and a second auxiliary motor arranged so as to produce a first opening movement of said sliding door.

2. The device of claim 1, wherein said second auxiliary motor is arranged proximate to a first end of said passage to act directly on an abutting surface of said sliding door.

3. The device of claim 2, wherein said second auxiliary motor is constituted by a worm-gear pusher motor, comprising a first electric motor having a first driving shaft; a pushing piston; a first reduction unit connected to said first electric motor and adapted to convert rotary motion of said first driving shaft into advancement motion of said pushing piston, wherein a free end of said pushing piston interacts, during said first opening movement, with said abutting surface of said sliding door.

4. The device of claim 2, wherein said second auxiliary motor is constituted by an eccentric-element motor, which comprises a second reduction unit; a second driving shaft protruding therefrom; a second electric motor that interacts with the second reduction unit from which the second driving shaft protrudes axially, and an eccentric bearing, which is keyed onto said second driving shaft, a perimetric edge of said eccentric bearing interacting, during said first opening movement, with said abutting surface of said sliding door.

5. The device of claim 2, wherein said abutting surface of said sliding door is constituted by a lateral edge of said sliding door.

6. The device of claim 2, wherein said abutting surface of said sliding door is constituted by a lug that protrudes in any of an upward or lateral direction away from said sliding door.

7. The device of claim 1, wherein said first driving motor is selected to deliver just a power required to perform only horizontal sliding of said sliding door after said first opening movement.

8. The device of claim 7, further comprising a control panel and control and synchronization means for controlling actuation of said first driving motor and said second auxiliary motor.
